(19) United States
(12) Patent Application Publication
(10) Pub. No.: US 2006/0274690 A1
(43) Pub. Date: Dec. 7, 2006

(54) Communicating control information in mobile communication system

(75) Inventors: Sung Duck Chun, Anyang city (KR); Young Dae Lee, HaNam-shi (KR); Myung Cheul Jung, Seoul (KR)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: LG Electronics Inc.

(21) Appl. No.: 11/417,563

(22) Filed: May 3, 2006

(30) Foreign Application Priority Data
May 3, 2005 (KR) 10-2005-37306

(51) Int. Cl. H04Q 7/00

(52) U.S. Cl. 370/329

(57) ABSTRACT

The present invention relates to communicating control information in a mobile communication system. Preferably, a mobile terminal efficiently transmits the control information to a base station enabling schedule and non-scheduled transmissions. The present invention comprises determining whether control information needs to be transmitted, configuring a data block for transmission, wherein existing data to be transmitted are placed in the data block according to a priority scheme, placing the control information in the data block if it is determined that the control information needs to be transmitted, wherein the control information has a higher priority than the existing data to be transmitted, and transmitting the data block.

### CROSS-REFERENCE TO RELATED APPLICATIONS

Pursuant to 35 U.S.C. § 119(a), this application claims the benefit of earlier filing date and right of priority to Korean Application No. P2005-0037306, filed on May 3, 2005, the content of which is hereby incorporated by reference herein in its entirety.

### FIELD OF THE INVENTION

The present invention relates to communicating control information in a mobile communication system, and more particularly, to communicating control information in a mobile communication system enabling a scheduled transmission scheme and a non-scheduled transmission scheme.

### BACKGROUND OF THE INVENTION

FIG. 1 is a block diagram of a network structure of a universal mobile telecommunications system (UMTS). Referring to FIG. 1, a UMTS mainly includes a user equipment (UE), a UMTS terrestrial radio access network (UTRAN), and a core network (CN).

The UTRAN includes at least one radio network sub-system (hereinafter abbreviated RNS). The RNS includes one radio network controller (RNC) and at least one base station (Node B) managed by the RNC. At least one or more cells exist in one Node B.

FIG. 2 is an architectural diagram of a radio interface protocol between the UE (user equipment) and the UTRAN (UMTS terrestrial radio access network). Referring to FIG. 2, a radio interface protocol vertically includes a physical layer, a data link layer, and a network layer. Horizontally, the radio interface protocol includes a user plane for data information transfer and a control plane for signaling transfer.

The protocol layers in FIG. 2 can be divided into a first layer (L1), a second layer (L2), and a third layer (L3) such as the three lower layers of an open system interconnection (OSI) standard model widely known in the art. The respective layers in FIG. 2 are explained as follows.

A physical layer (PHY) is the first layer and offers an information transfer service to an upper layer using a physical channel. The physical layer (PHY) is connected to a medium access control (MAC) layer located above the physical layer PHY via a transport channel. Data is transferred between the MAC layer and the PHY layer via the transport channel. Moreover, data is transferred between different physical layers, and more particularly, between a physical layer of a transmitting side and a physical layer of a receiving side via the physical channel.

The MAC layer of the second layer offers a service to a radio link control (RLC) layer located above the MAC layer via a logical channel. The MAC layer can also be divided into a MAC-b sublayer, a MAC-d sublayer, a MAC-c/sh sublayer, a MAC-hs sublayer and a MAC-e sublayer according to the types of transport channels managed in detail.

The MAC-b sublayer takes charge of managing a transport channel such as a broadcast channel (BCH) responsible for broadcasting system information. The MAC-c/sh sublayer manages a shared transport channel, which is shared by other UEs. A forward access channel (FACH) and a downlink shared channel (DSCH) are examples of a shared transport channel. The MAC-d sublayer takes charge of managing a dedicated transport channel such as a DCH (dedicated channel) for a specific UE. The MAC-hs sublayer manages a transport channel such as a high speed downlink shared channel (HS-DSCH) for supporting high speed data transfer in downlink and uplink. The MAC-e sublayer manages a transport channel such as an enhanced dedicated channel (E-DCH) for uplink data transfer.

FIG. 3 is a diagram of a structural example of DCH and E-DCH. Referring to FIG. 3, both DCH and E-DCH are transport channels that can be dedicatedly used by one user equipment (UE). In particular, the E-DCH is used by a user equipment to transfer data to a UTRAN in uplink. Compared to the DCH, the E-DCH can transfer uplink data faster than the DCH. To transfer data at high speed, the E-DCH adopts a technique such as hybrid automatic repeat request (HARQ), adaptive modulation and coding (AMC) and scheduling controlled by a Node B, for example.

For E-DCH, the Node B transfers to the UE downlink control information for controlling the UE's E-DCH transfer. The downlink control information includes response information (ACK/NACK) for HARQ, channel quality information for AMC, E-DCH transport rate assignment information, E-DCH transport start time and transport time interval assignment information, and transport block size information, for example. Meanwhile, the UE transfers uplink control information to the Node B. The uplink control information includes E-DCH rate request information for Node B controlled scheduling, UE buffer status information, and UE power status information, for example. The uplink and downlink control information for E-DCH is transferred via a physical control channel such as an enhanced dedicated physical control channel (E-DPCCH).

A MAC-d flow is defined between a MAC-d sublayer and a MAC-e sublayer for E-DCH. In this case, a dedicated logical channel is mapped to the MAC-d flow. The MAC-d flow is mapped to a transport channel E-DCH, and the E-DCH is mapped to another physical channel E-DPDCH (enhanced dedicated physical data channel). On the other hand, the dedicated logical channel can be directly mapped to DCH. In this case, the transport channel DCH is mapped to a dedicated physical data channel (DPDCH). The MAC-d sublayer in FIG. 3 manages the DCH (dedicated channel) as a dedicated transport channel for a specific user equipment, while the MAC-e sublayer manages the E-DCH (enhanced dedicated channel) as a transport channel used in transferring fast data in uplink.

A MAC-d sublayer of a transmitting side configures a MAC-d protocol data unit (PDU) from a MAC-d service data unit (SDU) delivered from an upper layer, i.e., an RLC layer. A MAC-d sublayer of a receiving side facilitates recovery of the MAC-d SDU from the MAC-d PDU received from a lower layer and delivers the recovered MAC-d SDU to an upper layer. In doing so, the MAC-d exchanges the MAC-d PDU with a MAC-e sublayer via a MAC-d flow or exchanges the MAC-d PDU with a physical layer via the DCH. The MAC-d sublayer of the receiving side recovers the MAC-d PDU using a MAC-d header attached to the MAC-d PDU prior to delivering the recovered MAC-d SDU to an upper layer.

A MAC-e sublayer of a transmitting side configures a MAC-e PDU from a MAC-e SDU corresponding to a MAC-d PDU delivered from an upper layer, i.e., a MAC-d sublayer. The MAC-e sublayer of a receiving side facilitates recovery of the MAC-e SDU from the MAC-e PDU received from a lower layer, i.e., a physical layer and delivers the recovered MAC-e SDU to a higher layer. In doing so, the MAC-e exchanges the MAC-e PDU with the physical layer via the E-DCH. The MAC-e sublayer of the receiving side recovers the MAC-e SDU using a MAC-e header attached to the MAC-e PDU prior to delivering the recovered MAC-e SDU to a higher layer.

FIG. 4 is a diagram of a protocol for E-DCH. Referring to FIG. 4, a MAC-e sublayer supporting E-DCH exists below a MAC-d sublayer of a UTRAN. Furthermore, a MAC-e sublayer supporting E-DCH exists below a MAC-d sublayer of a UE. The MAC-e sublayer of the UTRAN is located at a Node B. The MAC-e sublayer exists in each UE. On the other hand, the MAC-d sublayer of the UTRAN is located at a serving radio network controller (SRNC) in charge of managing a corresponding UE. The MAC-d sublayer exists in each UE.

Control information transmission for E-DCH is explained as follows. First of all, a scheduler exists at a Node B for E-DCH. The scheduler facilitates the allocation of an optimal radio resource to each UE existing within one cell to raise transmission efficiency of data in an uplink transfer at a base station from all UEs within each cell. In particular, more radio resources are allocated to a UE having a good channel status in one cell to enable the corresponding UE to transmit more data. Less radio resources are allocated to a UE having a poor channel status to prevent the corresponding UE from transmitting interference signals over an uplink radio channel.

When allocating radio resources to the corresponding UE, the scheduler does not only consider a radio channel status of a UE. The scheduler also requires control information from UEs. For example, the control information includes a power quantity the UE can use for E-DCH or a quantity of data the UE attempts to transmit. Namely, even if the UE has a better channel status, if there is no spare power the UE can use for E-DCH, or if there is no data the UE will transmit in an uplink direction, a radio resource should not be allocated to the UE. In other words, the scheduler can raise the efficiency of radio resource use within one cell only if a radio resource is allocated to a UE having a spare power for E-DCH and data to be transmitted in the uplink transfer.

Accordingly, a UE should send control information to a scheduler of a Node B. The control information can be transmitted in various ways. For instance, a scheduler of a Node B can instruct a UE to report that data to be transmitted in uplink exceeds a specific value or to periodically send control information to the Node B itself.

In case a radio resource is allocated to a UE from a scheduler of a Node B, the UE configures a MAC-e PDU within the allocated radio resource and then transmits the MAC-e PDU to a base station via E-DCH. In particular, if there exists data to be transmitted, a UE sends control information to a Node B to inform the Node-b that there is data to be transmitted by the UE. A scheduler of the Node B then sends information indicating that a radio resource allocation will be made to the UE based on the control information been sent by the UE. In this case, the information indicating the radio resource allocation means a maximum value of power the UE can transmit in uplink, a ratio for a reference channel, etc. The UE configures the MAC-e PDU within a permitted range based on the information indicating the radio resource allocation and transmits the configured MAC-e PDU.

Meanwhile, for a Voice over Internet Protocol (VoIP) service, a voice communication service is considerably sensitive to a delivery delay. Namely, the delivery delay in a transmission process degrades the quality of voice communication. Thus, such a service must minimize the delivery delay of data communicated wirelessly. However, in a process where a UE informs a Node B of the existence of data, where a resource is allocated to the UE by the Node B and where data is transmitted via a MAC-e PDU, the delivery delay inevitably occurs.

For such a service, a network allows a predetermined quantity of data to be transmitted for a channel from a UE at any time. This scheme is called a non-scheduled transmission. In particular, the UE can transmit data in uplink at any time within a non-scheduled grant for a channel set to a non-scheduled transmission. Alternatively, a scheme where a UE indicates an existence of data, where a radio resource allocation is made to the UE by a Node B and where the UE transmits the data, is called a scheduled transmission. In this case, a quantity of a radio resource allocated by the Node B is called a scheduled grant.

Accordingly, the channel set to the scheduled transmission is unable to use a resource set to the non-scheduled transmission even if the resource set for the non-scheduled grant is not used entirely due to the insufficient data of the channel set to the non-scheduled transmission. Similarly, this principle is applicable to the scheduled transmission.

For example, if a non-scheduled grant is 100, a scheduled grant is 50, a quantity of data corresponding to a non-scheduled transmission is 30 and a quantity of data corresponding to a scheduled transmission is 150, the substantially transmitted data includes non-scheduled transmission data 30 and scheduled transmission data 50. Namely, although 100 of the data to be transmitted by the scheduled transmission still remains and even if 70 of the data can be further transmitted by the non-scheduled transmission, the data set to the scheduled transmission is transmitted using the scheduled grant only or the data set to the non-scheduled transmission is transmitted using the non-scheduled grant only.

However, in the related art, in case that a UE allocates both scheduled and non-scheduled grants, which are allocated to itself, to a data transmission, the UE is unable to send control information to a Node B.

### SUMMARY OF THE INVENTION

The present invention is directed to communicating control information in a mobile communication system.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a method for communicating control information in a mobile communication system, the method comprising determining whether control information needs to be transmitted, configuring a data block for transmission, wherein existing data to be transmitted are placed in the data block according to a priority scheme, placing the control information in the data block if it is determined that the control information needs to be transmitted, wherein the control information has a higher priority than the existing data to be transmitted, and transmitting the data block.

Preferably, the existing data to be transmitted is at least one of existing data to be transmitted according to a scheduled transmission, and existing data to be transmitted according to a non-scheduled transmission. In one aspect, the control information is placed in the data block by utilizing resources allocated to the existing data to be transmitted according to a scheduled transmission. In another aspect, the control information is placed in the data block by utilizing resources allocated to the existing data to be transmitted according to a non-scheduled transmission. In a further aspect, the control information is placed in the data block by utilizing an additionally available non-scheduled grant.

Preferably, priority for the existing data is related to a logical channel through which the existing data is delivered.

Preferably, the control information comprises scheduling information, wherein the scheduling information comprises highest priority logical channel identifier, total E-DCH buffer status, highest priority logical channel buffer status, and mobile terminal power headroom.

Preferably, the data block is a MAC-e PDU and is transmitted through a transport channel in an uplink direction, wherein the transport channel is an enhanced dedicated channel (E-DCH).

Preferably, in the priority scheme, data of a logical channel having higher priority will be placed in the data block before data of a logical channel having lower priority.

In accordance with another embodiment of the present invention, a mobile terminal for communicating control information in a mobile communication system comprises a processor adapted to determine whether control information needs to be transmitted, configure a data block for transmission, wherein existing data to be transmitted are placed in the data block according to a priority scheme and place the control information in the data block if it is determined that the control information needs to be transmitted, wherein the control information has a higher priority than the existing data to be transmitted. The mobile terminal also comprises a transmitter controlled by the processor for transmitting the data block.

Preferably, the existing data to be transmitted is at least one of existing data to be transmitted according to a scheduled transmission, and existing data to be transmitted according to a non-scheduled transmission. In one aspect, the control information is placed in the data block by utilizing resources allocated to the existing data to be transmitted according to a scheduled transmission. In another aspect, the control information is placed in the data block by utilizing resources allocated to the existing data to be transmitted according to a non-scheduled transmission. In a further aspect, the control information is placed in the data block by utilizing an additionally available non-scheduled grant.

Preferably, priority for the existing data is related to a logical channel through which the existing data is delivered.

Preferably, the control information comprises scheduling information, wherein the scheduling information comprises highest priority logical channel identifier, total E-DCH buffer status, highest priority logical channel buffer status, and mobile terminal power headroom.

Preferably, the data block is a MAC-e PDU and is transmitted through a transport channel in an uplink direction, wherein the transport channel is an enhanced dedicated channel (E-DCH).

Preferably, in the priority scheme, data of a logical channel having higher priority will be placed in the data block before data of a logical channel having lower priority.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a block diagram of a network structure of a universal mobile telecommunications system (UMTS).

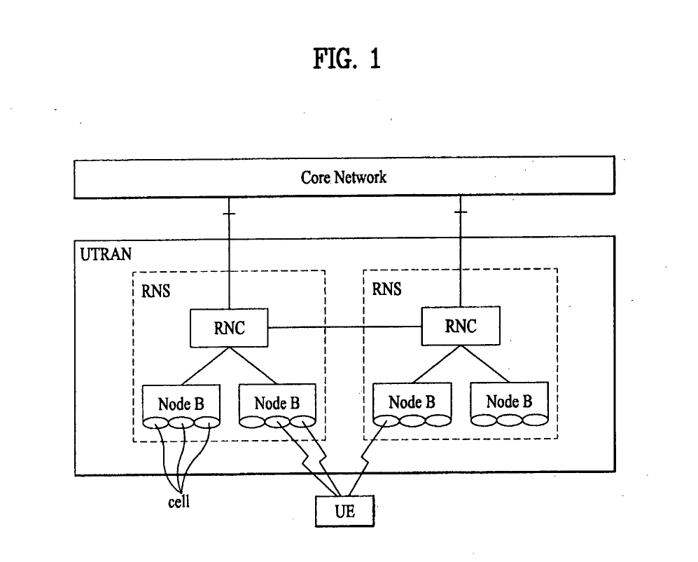

FIG. 2 is an architectural diagram of a radio interface protocol between a user equipment (UE) and a UMTS terrestrial radio access network (UTRAN).

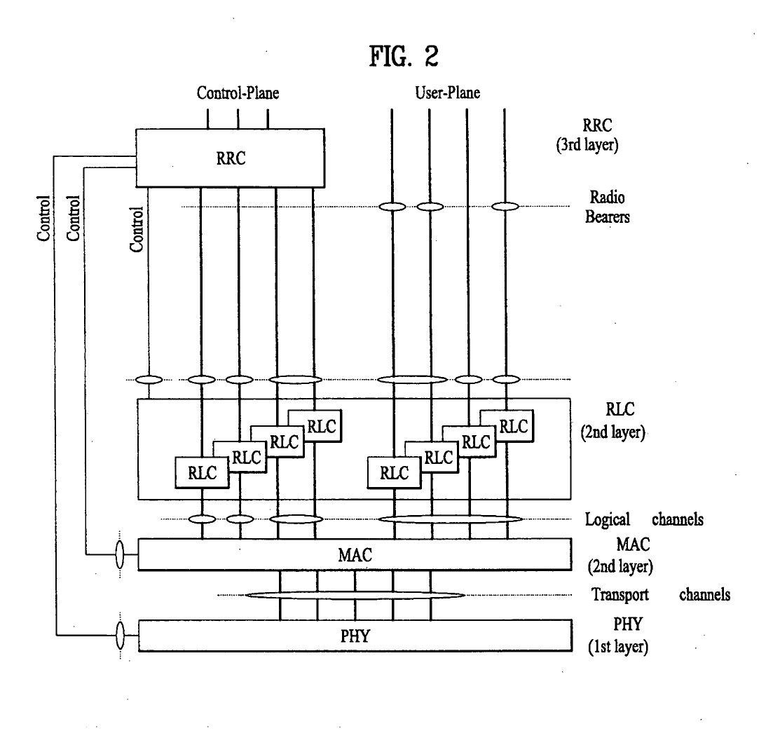

FIG. 3 is a diagram of a structural example of a dedicated channel (DCH) and an enhanced dedicated channel (E-DCH).

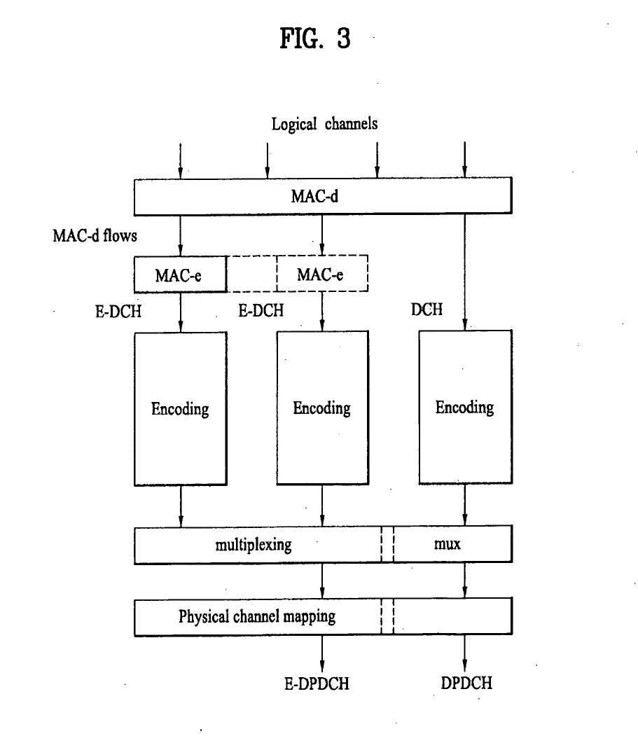

FIG. 4 is a diagram of a protocol for E-DCH.

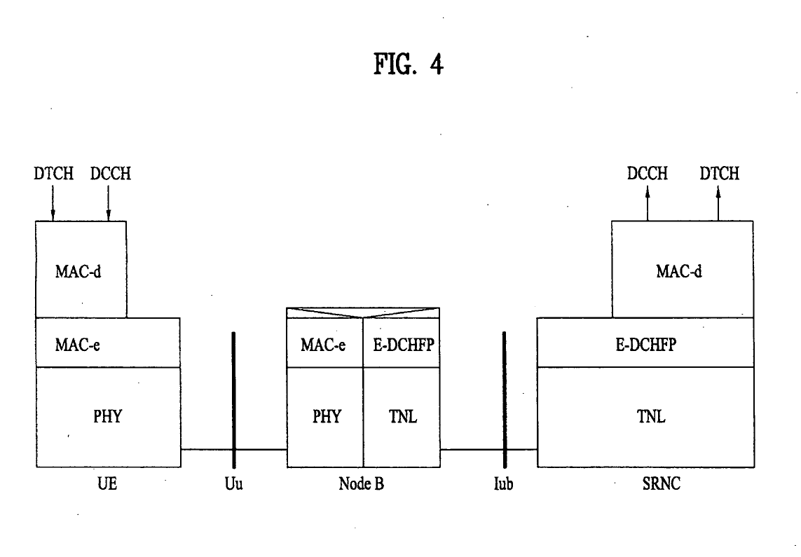

FIG. 5 is a flow chart for communicating control information in accordance with one embodiment of the present invention.

FIG. 6 is a block diagram of a mobile communication device in accordance with one embodiment of the present invention.

### DETAILED DESCRIPTION OF THE PREFERRED EMBODIMENTS

The present invention relates to communicating control information in a mobile communication system.

Reference will now be made in detail to the preferred embodiments of the present invention, examples of which are illustrated in the accompanying drawings. Wherever possible, the same reference numbers will be used throughout the drawings to refer to the same or like parts.

In configuring a MAC-e PDU, a UE prioritizes channels associated with non-scheduled data and scheduled data within a non-scheduled and scheduled grant, respectively. Table 1 shows examples of a transport priority and a transmission grant of a channel.

TABLE 1

| Channel Index | Data | Priority |
|---|---|---|
| 1 (non-scheduled) | 10 | 3 |
| 2 (non-scheduled) | 100 | 1 |
| 3 (scheduled) | 50 | 2 |
| 4 (scheduled) | 100 | 4 |

Assuming that a non-scheduled grant is 120 and a scheduled grant is 120, resources are first allocated to a channel having a highest channel priority when configuring a data block such as a MAC-e PDU. Preferably, a total size of the MAC-e PDU is unable to exceed the sum of the non-scheduled grant and the scheduled grant. The configuration of the MAC-e PDU in the example of Table 1 is explained as follows.

Referring to Table 1, resource allocation begins with Channel 2, which has the highest priority among the channels in the table. As shown, data of Channel 2 has a quantity of 100. Therefore, because a remaining quantity of the non-scheduled grant is 120, 100 of the Channel 2 data is entirely included in the MAC-e PDU. Accordingly, a remaining quantity of the non-scheduled grant is 20 and a remaining quantity of the scheduled grant is 120 as a result of the allocation for Channel 2.

A channel having the next highest priority is Channel 3. Therefore, resources are allocated to Channel 3 next. As shown, data of Channel 3 has a quantity of 50. Therefore, because a remaining quantity of the scheduled grant is 120, all data of Channel 3 is included in the MAC-e PDU. Accordingly, a remaining quantity of the non-scheduled grant is 20 and a remaining quantity of the scheduled grant is 70.

A channel having the next highest priority is Channel 1. Therefore, resources are allocated to Channel 1 next. As shown, data of Channel 1 has a quantity of 10. Therefore, because a remaining quantity of the scheduled grant is 20, all data of Channel 1 is included in the MAC-e PDU. Accordingly, a remaining quantity of the non-scheduled grant is 10 and a remaining quantity of the scheduled grant is 70.

A channel having the next highest priority is Channel 4. Therefore, resources are allocated to Channel 4 next. As shown, data of Channel 4 has a quantity of 100; however, a remaining quantity of the scheduled grant is 70. Therefore, only 70 of the data of Channel 4 is included in the MAC-e PDU. Accordingly, a remaining quantity of the non-scheduled grant is 10 and a remaining quantity of the scheduled grant is 0.

Hence, the configured MAC-e PDU includes a data quantity of 10 of Channel 1, a data quantity of 100 of Channel 2, a data quantity of 50 of Channel 3 and a data quantity of 70 of Channel 4. However, during the above process for configuring the MAC-e PDU, control information a UE is to send to a base station such as a Node B may be generated. For example, it is assumed that a UE previously requests a resource allocation by notifying a Node B of a data quantity to be transmitted by the UE. The Node B then allocates a radio resource to the UE, and the UE continuously transmits data via E-DCH. In the course of the transmission process, if new data to be sent by the UE in uplink is generated, the UE should be provided with an additional resource allocation by notifying the Node B of a quantity of the new data. Accordingly, the UE is to additionally send control information to the Node B while transmitting data.

However, according to the above example, if the UE configures a MAC-e PDU by considering channels having data only, the UE is unable to send control information to the Node B after having used all the resources of the non-scheduled and scheduled grants allocated to it.

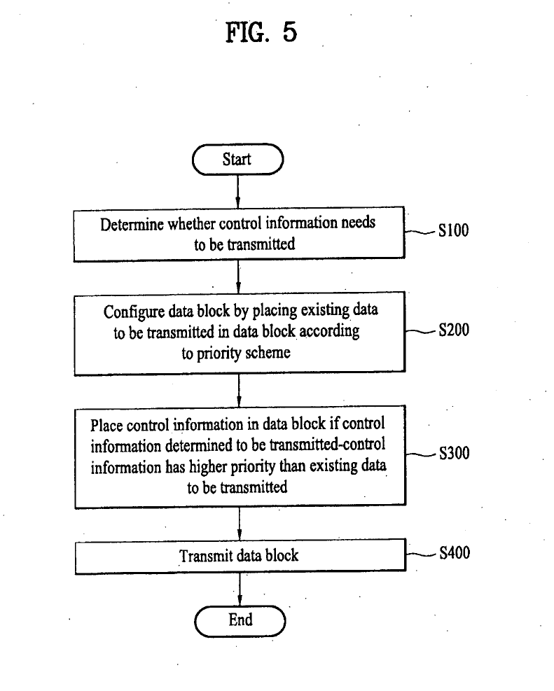

FIG. 5 is a flow chart for communicating control information in accordance with one embodiment of the present invention. Referring to FIG. 5, in accordance with the present invention, a UE determines whether control information is to be transmitted to a receiver, such as a Node B (S100). The UE also configures a data block, such as a MAC-e PDU according to a priority scheme. Preferably, the UE places existing data to be transmitted to the Node B in the data block according to the priority scheme (S200). Afterward, if it is determined that the control information is to be transmitted to the Node B, the control information is placed in the data block, wherein the control information has a priority higher than the existing data to be transmitted (S300). After configuration of the data block is complete, the data block is transmitted to the Node B (S400).

In accordance with one embodiment of the present invention, if there is no data corresponding to a channel or service corresponding to a non-scheduled transmission, if data exists in a channel or service corresponding to a scheduled transmission, and if no transmission is allowed for the channel corresponding to the scheduled transmission, the UE sends control information requesting a radio resource allocation to the Node B. In doing so, the UE can transmit control information to the Node B in a manner of configuring the control information within a non-scheduled grant set in the UE. Preferably, in case of sending the control information in uplink only, the UE can transmit the corresponding control information using the non-scheduled grant.

Thus, if no user data exists to be transmitted, the UE can immediately send the control information using the non-scheduled transmission. Hence, the UE can receive the radio resource allocation more quickly to reduce the delivery delay felt by a user.

Preferably, the control information requesting the radio resource allocation includes scheduling information comprising a quantity of data corresponding to a channel having a highest priority among several logical channels set in the UE (highest priority logical channel buffer status), a total of data accumulated in the logical channels set in the UE (total E-DCH buffer status), a power quantity usable for the uplink transmission by the UE (mobile terminal power headroom), and a highest priority logical channel identifier, for example.

Meanwhile, in sending control information to a Node B, in case of transmitting data of a channel or service corresponding to a non-scheduled transmission, a UE transmits the control information using a non-scheduled grant. Therefore, in accordance with one embodiment of the present invention, the control information is processed with a priority lower than that of any logical channel or service set to use the non-scheduled transmission. Accordingly, in configuring a MAC-e PDU, the UE first includes data of the logical channel or service set to use the non-scheduled transmission in order of highest priorities in the MAC-e PDU. After having included the data in the MAC-e PDU entirely, the UE then includes the control information in the MAC-e PDU if a spare space exists. Hence, by preferentially allocating the non-scheduled grant to another logical channel or service set to use the non-scheduled transmission, the control information is transmitted using the non-scheduled grant if a spare space exists.

In the above process, the control information is assigned a priority lower than that of the logical channel or service set to the non-scheduled transmission. Generally, information indicated by the control information is related to a logical channel or service set to a scheduled transmission. This logical channel or service is less sensitive to delivery delay such as in the case for the Internet. Conversely, the logical channel or service set to a non-scheduled transmission is considerably sensitive to delivery delay such as in the case for voice communications. Hence, the priority of the control information is set low.

However, the priority of the logical channel or service set to the non-scheduled transmission may not be higher than that of the control information. Namely, as a new service is introduced, the non-scheduled transmission is preferable. But, a service making no difference in having a low priority may take place. To prepare for this case, a Node B can inform a UE of a priority of control information. In this case, the UE compares the control information to a channel or service set to a non-scheduled transmission and then preferentially includes data of channels having a priority higher than the control channel priority in a MAC-e PDU. If a spare space exists, the control information is included in the MAC-e PDU. If a spare space still remains, data of a channel or service set to a non-scheduled transmission having a priority lower than the control information priority may be included in the MAC-e PDU.

If services or channels corresponding to a non-scheduled transmission are services less sensitive to a delivery delay such as streaming, the preferential transmission of control information is less important. However, if control information comprises very important information, such as power information of the UE, the control information is to be transmitted to a Node B more quickly. Accordingly, in the present invention, in transmitting control information to a Node B, the UE transmits control information using a non-scheduled transmission. Furthermore, the control information may be processed with a priority higher than that of any channel or service set to use the non-scheduled transmission.

Hence, in configuring the MAC-e PDU, the UE includes the control information in the MAC-e PDU preferentially using the non-scheduled transmission. Subsequently, the UE includes data of a logical channel or service set to use the non-scheduled transmission in the MAC-e PDU in order of their priorities, and as many as a spare quantity of a non-scheduled grant.

In sending control information to a Node B, a UE can use a control information grant separately set for a control information transmission. Preferably, a UTRAN additionally informs the UE of a value of a control information grant. The UE is then enabled to transmit control information amounting to the value in uplink at any time.

In the above process, the control information transmission may be set to a part of a non-scheduled transmission. In case that the control information transmission is set to a part of the non-scheduled transmission, a UTRAN can additionally inform the UE of a ratio indicating how much of a non-scheduled grant corresponds to a control information grant. Alternatively, in case that the control information transmission is set to a part of the non-scheduled transmission, the UTRAN can inform the UE of a control information grant separate from a non-scheduled grant.

In case that a control information grant is set to a part of the non-scheduled grant, the UE can transmit control information amounting to the control information grant at any time if control information to be transmitted exists. If a control information transmission is set to a part of a non-scheduled transmission, a UE can transmit control information amounting to a control information grant at any time if control information to be transmitted exists. If no control information to be transmitted exists, a UE can set the control information grant to be used by a logical channel or service set to a non-scheduled transmission. This enables the UE to transmit its data to a Node B more efficiently.

Meanwhile, if a control information transmission is set to a part of a non-scheduled transmission, a UE can send control information amounting to a control information grant in uplink at any time in case of having control information to be transmitted. If no control information to be transmitted exists, a UE can set the control information grant not to be used by a logical channel or service set to a non-scheduled transmission. This enables a Node B to use a spare radio resource for other purposes.

In accordance with one embodiment of the present invention, if data corresponding to a channel or service corresponding to a non-scheduled transmission does not exist in a UE, if data exists in a channel or service corresponding to a scheduled transmission, if a scheduled transmission of at least 0 is permitted for the channel corresponding to the scheduled transmission, and if a UE has control information to be transmitted to a Node B, then the UE transmits control information to the Node B by configuring the control information within a corresponding grant using a non-scheduled grant set to the UE.

In case that a UE is permitted to use a non-scheduled transmission, the UE can transmit data for a channel or service set to use a non-scheduled transmission at any time using the non-scheduled transmission. However, such data does not always exist in the UE. Nonetheless, the Node B does not know when the UE will make a transmission. Hence, the Node B should prepare a radio resource of the corresponding cell. Therefore, a UTRAN sets a non-scheduled transmission to be used for a service and a corresponding channel if the service requires a non-scheduled transmission. Otherwise, if the services can be sufficiently provided using a scheduled transmission, the UTRAN may not give a non-scheduled grant to the UE. However, in the present invention, control information to be transmitted to the Node B from the UE may exist.

Therefore, in accordance with one embodiment of the present invention, if data corresponding to a channel or service corresponding to a non-scheduled transmission does not exist in a UE, if data exists in a channel or service corresponding to a scheduled transmission, if a scheduled transmission of at least 0 is permitted for the channel corresponding to the scheduled transmission, and if a UE has control information to be transmitted to a Node B, then the UE transmits control information to the Node B by configuring the control information within a corresponding grant using a scheduled grant set to the UE.

Since control information affects a quality of channel or service set to use a scheduled transmission, a UE is made to process the control information with a priority higher than that of a channel or service set to use the scheduled transmission. In configuring a MAC-e PDU, the UE preferentially includes the control information in the MAC-e PDU using a scheduled grant, allocates a spare of the scheduled grant to data of the logical channel or service set to use the scheduled transmission and then includes data in the MAC-e PDU in order of higher priorities.

Preferably, a Node B is made to inform a UE of a priority of control information. The UE can then set the control information to use a scheduled transmission. Preferably, the UE compares the control information to the channel or service set to the scheduled transmission with data and preferentially includes data of channels having priorities higher than that of the control channel in the MAC-e PDU. Subsequently, if there is a spare space, the UE includes the control information in the MAC-e PDU. If the spare space further remains, the UE may include data of a channel or service set to a priority lower than that of the control information in the MAC-e PDU.

Accordingly, if no channel or service set to use a non-scheduled transmission exists, the UE sends control information like a non-scheduled transmission in case of being set to the non-scheduled transmission with no grant. Preferably, the UE entirely uses a scheduled grant in transmitting data of a channel or service set to use a scheduled transmission. If there is control information to be transmitted, the UE additionally includes the control information in a MAC-e PDU at any time.

By taking the importance of control information into consideration, a non-scheduled grant is used for a transmission of data of a channel or service set to a non-scheduled transmission only and a scheduled grant is used for a transmission of data of a channel or service set to a scheduled transmission only. If control information to be transmitted to a Node B exists, the control information is additionally included in a MAC-e PDU at any time regardless of a priority of a non-scheduled or scheduled transmission.

By taking the importance of control information into consideration, a non-scheduled grant is used for a transmission of data of a channel or service set to a non-scheduled transmission only and a scheduled grant is used for a transmission of data of a channel or service set to a scheduled transmission only. If a spare of the non-scheduled grant exists, the control information is additionally included in the MAC-e PDU using the spare.

By taking the importance of control information into consideration, a non-scheduled grant is used for a transmission of data of a channel or service set to a non-scheduled transmission only and a scheduled grant is used for a transmission of data of a channel or service set to a scheduled transmission only. If a spare of the scheduled grant exists, the control information is additionally included in a MAC-e PDU using the spare.

By taking the importance of control information into consideration, a non-scheduled grant is used for a transmission of data of a channel or service set to a non-scheduled transmission only and a scheduled grant is used for a transmission of data of a channel or service set to a scheduled transmission only. If a spare of the non-scheduled grant is insufficient for a transmission of the control information, if a sum of a spare of the scheduled grant and a spare of the non-scheduled grant is sufficient for a transmission of the control information, the control information is additionally included in a MAC-e PDU using the spares.

In case that a UE is set to transmit control information using a non-scheduled transmission to a Node B effectively, if the UE is unable to transmit the control information using a non-scheduled grant due to a shortage of the non-scheduled grant or excessive data of another channel or service having a high priority set to use the non-scheduled transmission, then the UE transmits the control information using a scheduled grant. In doing so, a priority of the control information is processed higher than that of any other logical channel or service set to use the scheduled transmission to configure a MAC-e PDU. The UE then transmits the configured MAC-e PDU.

In case that a UE is set to transmit control information using a non-scheduled transmission to a Node B effectively, if the UE is unable to transmit the control information using a non-scheduled grant due to a shortage of the non-scheduled grant or excessive data of another channel or service having a high priority set to use the non-scheduled transmission, the UE includes the control information in a MAC-e PDU regardless of a scheduled grant.

In accordance with one embodiment of present invention, to enable a UTRAN to set a control information transmission of a UE more efficiently, the UTRAN instructs the UE whether to send the control information using a scheduled transmission or a non-scheduled transmission. The UTRAN may also inform the UE of a priority of the control information in order for the UE to decide whether the MAC-e PDU should include the control information when configuring the MAC-e PDU. Preferably, the UE fills the MAC-e PDU within a range of a non-scheduled grant for a channel set to a non-scheduled transmission and fills the MAC-e PDU within a range of a scheduled grant for a channel set to a scheduled transmission. In doing so, the MAC-e PDU is configured in order of priority of each logical channel.

To prevent a UE from transmitting control information to a Node B unnecessarily, the Node B can inform the UE of an indicator for indicating whether the UE should transmit the control information or not.

Accordingly, the present invention allows for the communication of control information efficiently using scheduled and non-scheduled transmissions in a mobile communication system enabling both the scheduled and non-scheduled transmissions.

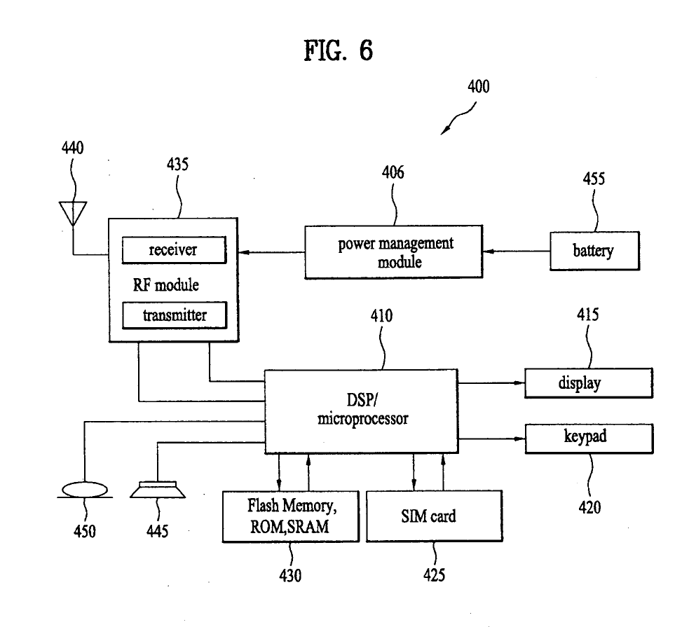

Referring to FIG. 6, a block diagram of a mobile communication device 400 of the present invention is illustrated, for example a mobile phone for performing the methods of the present invention. The mobile communication device 400 includes a processing unit 410 such as a microprocessor or digital signal processor, an RF module 435, a power management module 406, an antenna 440, a battery 455, a display 415, a keypad 420, a storage unit 430 such as flash memory, ROM or SRAM, a speaker 445 and a microphone 450. A SIM card 425 may optionally be included.

A user enters instructional information, such as a telephone number, for example, by pushing the buttons of a keypad 420 or by voice activation using the microphone 450. The processing unit 410 receives and processes the instructional information to perform the appropriate function, such as to dial the telephone number. Operational data may be retrieved from the storage unit 430 to perform the function. Furthermore, the processing unit 410 may display the instructional and operational information on the display 415 for the user's reference and convenience.

The processing unit 410 issues instructional information to the RF module 435, to initiate communication, for example, transmits radio signals comprising voice communication data. The RF module 435 comprises a receiver and a transmitter to receive and transmit radio signals. The antenna 440 facilitates the transmission and reception of radio signals. Upon receiving radio signals, the RF module 435 may forward and convert the signals to baseband frequency for processing by the processing unit 410. The processed signals would be transformed into audible or readable information outputted via the speaker 445, for example.

The processing unit 410 is adapted to determine whether control information needs to be transmitted, configure a data block for transmission, wherein existing data to be transmitted are placed in the data block according to a priority scheme and place the control information in the data block if it is determined that the control information needs to be transmitted, wherein the control information has a higher priority than the existing data to be transmitted. A transmitter of RF module 435 is controlled by the processing unit 410 to transmit the data block.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method for communicating control information in a mobile communication system, the method comprising:
determining whether control information needs to be transmitted;
configuring a data block for transmission, wherein existing data to be transmitted are placed in the data block according to a priority scheme;
placing the control information in the data block if it is determined that the control information needs to be transmitted, wherein the control information has a higher priority than the existing data to be transmitted; and
transmitting the data block.

2. The method of claim 1, wherein the existing data to be transmitted is at least one of:
existing data to be transmitted according to a scheduled transmission; and
existing data to be transmitted according to a non-scheduled transmission.

3. The method of claim 2, wherein the control information is placed in the data block by utilizing resources allocated to the existing data to be transmitted according to a scheduled transmission.

4. The method of claim 2, wherein the control information is placed in the data block by utilizing resources allocated to the existing data to be transmitted according to a non-scheduled transmission.

5. The method of claim 1, wherein the control information is placed in the data block by utilizing an additionally available non-scheduled grant.

6. The method of claim 1, wherein priority for the existing data is related to a logical channel through which the existing data is delivered.

7. The method of claim 1, wherein the control information comprises scheduling information.

8. The method of claim 1, wherein the scheduling information comprises:
highest priority logical channel identifier;
total E-DCH buffer status;
highest priority logical channel buffer status; and
mobile terminal power headroom.

9. The method of claim 1, wherein the data block is a MAC-e PDU.

10. The method of claim 1, wherein the data block is transmitted through a transport channel in an uplink direction.

11. The method of claim 10, wherein the transport channel is an enhanced dedicated channel (E-DCH).

12. The method of claim 1, wherein in the priority scheme, data of a logical channel having higher priority will be placed in the data block before data of a logical channel having lower priority.

13. A mobile terminal for communicating control information in a mobile communication system, the mobile terminal comprising:
a processor adapted to:
determine whether control information needs to be transmitted;
configure a data block for transmission, wherein existing data to be transmitted are placed in the data block according to a priority scheme; and
place the control information in the data block if it is determined that the control information needs to be transmitted, wherein the control information has a higher priority than the existing data to be transmitted; and
a transmitter controlled by the processor for transmitting the data block.

14. The mobile terminal of claim 13, wherein the existing data to be transmitted is at least one of:
existing data to be transmitted according to a scheduled transmission; and
existing data to be transmitted according to a non-scheduled transmission.

15. The mobile terminal of claim 14, wherein the control information is placed in the data block by utilizing resources allocated to the existing data to be transmitted according to a scheduled transmission.

16. The mobile terminal of claim 14, wherein the control information is placed in the data block by utilizing resources allocated to the existing data to be transmitted according to a non-scheduled transmission.

17. The mobile terminal of claim 13, wherein the control information is placed in the data block by utilizing an additionally available non-scheduled grant.

18. The mobile terminal of claim 13, wherein priority for the existing data is related to a logical channel through which the existing data is delivered.

19. The mobile terminal of claim 13, wherein the control information comprises scheduling information.

20. The mobile terminal of claim 13, wherein the scheduling information comprises:
highest priority logical channel identifier;
total E-DCH buffer status;
highest priority logical channel buffer status; and
mobile terminal power headroom.

21. The mobile terminal of claim 13, wherein the data block is a MAC-e PDU.

22. The mobile terminal of claim 13, wherein the data block is transmitted through a transport channel in an uplink direction.

23. The mobile terminal of claim 22, wherein the transport channel is an enhanced dedicated channel (E-DCH).

24. The mobile terminal of claim 13, wherein in the priority scheme, data of a logical channel having higher priority will be placed in the data block before data of a logical channel having lower priority.
